(19) United States
(12) Patent Application Publication
(10) Pub. No.: US 2014/0049473 A1
(43) Pub. Date: Feb. 20, 2014

(54) USER-CONTROLLED KEYPAD ADVERTISING SYSTEM

(71) Applicant: Yuvee, Inc., Highland Park, IL (US)

(72) Inventor: Timothy B. Higginson, Highland Park, IL (US)

(73) Assignee: Yuvee, Inc., Highland Park, IL (US)

(21) Appl. No.: 13/970,237

(22) Filed: Aug. 19, 2013

Related U.S. Application Data
(60) Provisional application No. 61/684,554, filed on Aug. 17, 2012.

(51) Int. Cl. G06F 3/02

(52) U.S. Cl. CPC G06F 3/0219
USPC 345/168

(57) ABSTRACT

A computing device is described that is configured to incorporate a user-controlled keypad user interface that facilitates user-controlled focused advertising within a portion of the keypad. The device includes a keypad user interface comprising at least four sets of keys. Each of four sets of keys is separate and distinct from the each of the other sets of keys and includes: a first set of keypad-state determination keys, a second set of keypad-state determination keys, a set of keypad external action directive keys, and a set of advertising keys. Data structures store values and data for the keypad, and a combined selection from the first set of keypad-state determination keys and the second set of keypad-state determination keys determines values of both the keypad action keys and the advertising keys by setting index values for retrieving the values and data for the sets of keys from the keypad data structures.

### CROSS-REFERENCE TO RELATED APPLICATIONS

This patent application claims priority to Higginson, U.S. Provisional Application Ser. No. 61/684,554, filed Aug. 17, 2012, the contents of which are expressly incorporated herein by reference in their entirety, including any references therein.

This application also incorporates by reference in its entirety the disclosure of Higginson U.S. Pat. No. 6,703,963 for a “Universal Keyboard.” The disclosure of which includes a description of a multi-function, multi-domain level keypad/keyboard within which the physical and functional features described herein are advantageously incorporated.

### AREA OF THE INVENTION

The present invention generally relates to providing a device-based, keypad system for providing user-controlled advertising selection and display, whereby a user dynamically pulls advertisements into a set of advertisement placement areas associated with a set of advertising keys on the keypad based on a combination of (1) dynamic user-controlled advertising content preferences for the keypad, and (2) user-selected states of non-advertising keys.

### BACKGROUND

To date, the dominant systems for delivery of advertising to users of computing devices involving showing ads interspersed in the content on websites and/or in applications, based on analysis of and correlation among (a) content on the website/application; (b) user information collected from numerous sources, including the user's general web usage tracked by various means, including software cookies and related tracking software, the user's usage history and patterns when logged into sites, data acquired from third parties, such as credit card companies, data collected from the user's devices, such as location information, camera information and app information, user's search queries and shopping and buying histories and patterns; and (c) advertiser specifications for the advertiser's ad placement. These ad delivery systems attempt to match the content and/or user information to information in a database of advertisements, and then deliver advertisements for display on the website or in an application for viewing of and interaction with the ad by the user, based on algorithms that attempt to do an optimal match between the user and the advertisement.

These systems therefore collect as much data about the advertisement as possible, as much information about the content on websites or applications as possible, and as much information about the user as possible, both historically and on a real-time basis. These systems utilize algorithms and sophisticated database search software to correlate the data on as fast and relevant a time frame as possible in order to serve the most relevant ads to the user before the user moves on from the position where the ads are to be delivered to catch the user's attention.

The data collected and stored about the user frequently includes highly personal data collected across a span of time about the user's web surfing history, product interest history, device locations, device usage history, current device information (location, camera view, orientation, app usage, etc.)

The advertiser must rely on the system(s) offered by the ad delivery companies to deliver ads appropriate to the advertiser's preferences (as indicated by the advertiser to the ad delivery company) combined with the user data to place the ads in visually optimal places.

This poses many problems. Two important such problems include (1) there is an rapidly growing incentive to collect ever-more personal information about users, including their web-surfing habits, their app usage habits, details of their past and current usage of their devices (e.g., smartphone location), etc.; (2) the entirety of these systems essentially is based on using as much past and current data as possible to predict the current state of mind of a user in order to deliver the most relevant ads. In other words, the privacy of even the minutest details of people's lives gets tracked, store, analyzed and reported, and, even in the face of that, the advertisements may not reflect what the user really is interested in at the time the ads are delivered because the delivery is based on a predictive model that includes the user's past behavior to predict current and future interest, so the data inevitably lags the user's actual, real-time and future preferences, and, in any event, none of it can actually read the mind of the user.

### SUMMARY OF INVENTION/DISCLOSURE

A computing device is described that incorporates a user-controlled keypad user interface which facilitates user-controlled advertising on the keypad. In particular, the device includes a keypad user interface comprising at least four distinct sets of keys. Each of these four sets of keys is separate and distinct from the each of the other sets of keys, and the four sets include: a first set of keypad-state determination keys, a second set of keypad-state determination keys, a set of keypad external action directive keys, and a set of advertising keys. Moreover, data structures within the computing device store values and data for the keypad, and a combined selection from among the first set of keypad-state determination keys and among the second set of keypad-state determination keys determines the values of both the set of keypad action keys and the set of advertising keys by setting a set of index values for retrieving the values and data for the sets of keys from the keypad data structures.

Moreover, user-alterable fields within the data structures of the computing device store advertising topic identification values for specific ones of the first set of keypad-state determination keys and/or the second set of keypad-state determination keys; and the combination of each user's stored advertising topic identification values and his/her selection of specific ones of those first and/or second sets of keys determines the present, dynamically allocated values at any one time during use of both the set of keypad action keys and the set of advertising keys by setting a set of index values for retrieving the values and data for the sets of keys from the keypad data structures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 illustratively depicts a user-controlled ad key keypad user interface with a set of user-controlled pull advertising elements;

FIG. 2 illustratively depicts a user-controlled keypad user interface with pull advertising placement system wherein a key with a text label “Travel Hub” has been selected by a user;

FIG. 3 illustratively depicts a user-controlled pull advertising placement keypad user interface system wherein a key with a text label “Travel Hub” has been selected by the user;

FIG. 4 illustratively depicts a user-controlled pull advertising placement keypad user interface system wherein a key with a text label “Shop Hub” has been selected by the user;

FIG. 5 illustratively depicts a user-controlled pull advertising placement keypad user interface system wherein a key with a text label “Shop Hub” has been selected by the user;

FIG. 6 illustratively depicts a user-controlled pull advertising placement keypad user interface system wherein a key with a text label “Shop Hub” has been selected by the user;

FIG. 7 illustratively depicts a user-controlled keypad pull advertising placement system wherein a key with a text label “Sports Hub” has been selected by a user;

FIG. 8 illustratively depicts an exemplary environment wherein a keypad user interface, with a set of user-controlled pull advertising elements, is implemented as a software application delivered via a web browser application;

FIG. 9 illustratively depicts a view of an exemplary environment wherein a keypad user interface includes a set of user-controlled pull advertising elements and an edit mode key;

FIG. 10 illustratively depicts a user profile menu that opens when the user selects a “menu” key;

FIG. 11 illustratively depicts an edit mode key;

FIG. 12 illustratively depicts an information key;

FIG. 13 illustratively depicts a handheld computing and communications device with a keypad user interface system comprising a hybrid mechanical key with integrated display component construction with ad keys;

FIG. 14 illustratively depicts an implementation of a computing and communications device with a user-controlled keypad user interface system comprising a hybrid mechanical key with integrated display component construction with ad keys;

FIG. 15 illustratively depicts an implementation of a stand-alone keypad device with a user-controlled keypad user interface system comprising a hybrid mechanical key with integrated display component construction with ad keys;

FIG. 16 illustratively depicts an implementation of a remote control device for wirelessly controlling other devices;

FIG. 17 illustratively depicts an implementation of a touchscreen smartphone device with a user-controlled keypad user interface system with ad keys;

FIG. 18a illustratively depicts an exemplary flow chart summarizing a first set of steps by which a user activates a user-controlled keypad user interface system;

FIG. 18b is an exemplary flowchart summarizing a set of steps for the context when a user has activated a “menu” key as described in FIG. 18a;

FIG. 18c describes the menu options and associated actions when a user opens the menu of personal ad settings as described in the description for FIG. 18b;

FIG. 18d is an exemplary flow chart summarizing a set of steps for the context when a user elects to access/change/set/view the user's settings, including ad parameters/filters, for individual sets of keys; and

FIG. 18e describes the menu options and associated actions when a user opens the menu of personal ad settings for individual sets of keys as described in the description for FIG. 18d.

### DETAILED DESCRIPTION OF THE DRAWINGS

The aforementioned shortcomings of current advertising delivery systems to provide relevant ads via the Internet and wireless networks to websites and applications viewed and used on devices is addressed by a device-based, keypad system that lets user's identify, control and change their ad preferences on a dynamic basis across a wide range of contexts. This delivers more relevant ads to the user, gives the user immediate control over the advertising presented to the user. It also avoids the requirements to track and compile personal data, analyze personal data, maintain extensive databases of personal data about vast numbers of the population, develop search and database analysis software and algorithms and associated problems, such as the risk to the user of third parties misusing the personal data, exposing the personal data inadvertently, having the personal data hacked, and managing the personal data of users covered by different national, multi-national and international privacy rules and regulations.

The device-based, keypad user interface incorporates a set of advertising keys separate and distinct from the other keys in the keypad user interface. These advertising keys are dynamically-defined by combining (1) a set of user-defined preferences for advertisements stored in a data structure with (2) the current states of two sets of tiered, controlling non-advertising keys. The two sets of tiered, non-advertising keys have dual roles of (a) determining the values of a third set of non-advertising, and (b) determining the index values for a set of advertising keys. The selection of the states of the keypad by the user defines a current state of values of the advertising keys according to (1) the top tier of keys defining a first index value into a relational database that determines the state of the other non-advertising keys of keypad user interface at any one time, and (2) the second tier of keys defining a second index value. Further, the data structure stores the user's preference for ad category delivery according to these two-tiered sets of keys, as such preferences have been entered by the user into the system as enabled by the keypad user interface.

Because the user creates his/her own identity for the keypad user interface system, which requires no personally identifiable information, the user's preferences submitted to the system by the user are not tied to the user's personal identity (unless the user elects to enter personally identifiable information), and the system delivers ads relevant to the user's entered preferences with no need for storing, collecting, analyzing or searching the user's personal information of any kind, and no degradation of relevance of ad in the absence of personally identifiable information, but, instead, an increase in relevance of delivered ads across a spectrum of the user's interests, regardless of how those interests change from moment-to-moment. This system does not rely on predicting the state of mind of the user to delivery ad content, but, instead, reacts instantly to the actual state of the keypad as determined by the user to select ads to deliver to the user.

The keypad user interface also includes a first set of programmable displays associated with, but separate from, the key sets, as well as programmable displays associated with the ad keys.

A keypad data structure is also included in the device or is associated with the user in a database accessed by the device where the keypad is incorporated. The keypad data structure, by way of example a table in a database, includes a set of entries corresponding to the two sets of tiered keys, as well as the user's ad preferences at each level of the keypad structure: (1) default ad preferences independent of the two tiers of keys for ad delivery when the user has not set preferences specific to any of the keys in the two tiers or the user sets preferences that govern the keys in the two tiers, (2) ad preferences for one or more of the top tier of keys, for use when a user has not set preferences at any key in the second tier that is indexed via this first tier, and (3) ad preferences for one or more of the keys in the second tier.

Each ad key entry in the data structure (e.g., table) includes a pointer array (defined by the preferences set by the user in the preceding paragraph) that indexes into a local or remote data structure (e.g., table) of advertisements which have been tagged (or otherwise organized or identified) according to information matching to the preferences selectable by the user to set the values for the preferences identified in the preceding paragraph as well as with information provided by the advertiser containing the advertiser's preferences and/or directions for how, where and when its advertisements may or should be delivered (e.g., positively or negatively, by time of day, by device category, by descriptive content, by user demographic, by location).

An accounting function associates delivery of an ad to an ad key pursuant to the foregoing system, as well as to a user action involving the ad key, such as a key press or finger gesture.

The user is provided a key-based means for changing his/her ad preferences immediately and directly at any of the foregoing levels on a dynamic basis.

In a further, specific implementation of the keypad, the keypad includes an “advertiser” state whereby a press of the ad keys themselves triggers a set of menus and input options delivering the ability for advertisers to bid on a specific ad key wherein the advertiser's ad information for that ad key (as determined by the keypad state according to the advertiser's selection of the non-advertising keys, working precisely as the selection of non-advertising keys by an end-user works to determine a set of ad keys as described above) is entered by the advertiser, including, for instance, the ad placement price bid made by the advertiser (such as a price per click on the ad) and upon confirmation by the advertiser, that ad key information is logged into the master ad key database. The information entered by the advertiser includes, in addition to the pricing information described in the foregoing sentence, other information relevant to the ad, such as the ad content, link(s) associated with the ad, the advertiser's (or ad agency's) business and contact and billing information, tags associated with the ad (that the system uses to match relevant ads to user-determined ad preferences), ad limitations set by the advertiser (such as geographic limitations, device type limitations, operating system, date and/or time limitations for the ad, ad budget limitations (such as an overall ad budget for the ad, daily ad budget for the ad)) and links to the advertiser's master account, master settings and other ad campaigns, such as is maintained within the master ad key database.

Thus, in addition to providing an arrangement for automatically delivering relevant ads to current instances of the keypad by means of combining the user's ad preference indicators with the user's selection of the two tiers of keypad-state determination keys, the disclosed system and methods provide a mechanism for charging content sponsors (e.g., an ad sponsor company, or an agency representing such a company) on a monthly (or other time period) or click-through basis. The charge may be performed and received by the company managing the keypad system, or one or more third parties participating in delivering remotely managed parts of the keypad system, such as a company with an existing on-line ad inventory, delivery and accounting system, or the device manufacturer of a device incorporating the user-controlled ad keypad system, or a company providing telecommunications services to the device, thereby enabling that company to receive revenue independent of the charging the subscriber fees for voice or data services and, also potentially allowing subsidization of the device cost through revenue received from content sponsors over the duration of use of the device by a subscriber.

Attention is directed to the set of figures. The figures illustratively depict a user-controlled ad keypad user interface system for user-controlled ad delivery to a set of keys on the keypad dedicated to ads.

The diagrams and images generally show a keypad user interface comprising a set of hybrid display/physical and/or touchscreen displayed keys dedicated to implementing a keypad system that simultaneously (1) encompasses an almost unlimited set of states stored in database structures for entering commands to control applications together with a tiered allocation of roles to sets of keys such that the user can quickly and easily access any specific set of commands from within the datastructures and display and utilize the commands on one of the sets of keys of the keypad, and (2) display ads on a set of dedicated ad keys based on the selected state of the other sets of keys combined with parameters for the ads which parameters are dynamically set by the user at any time during use of the keypad user interface system.

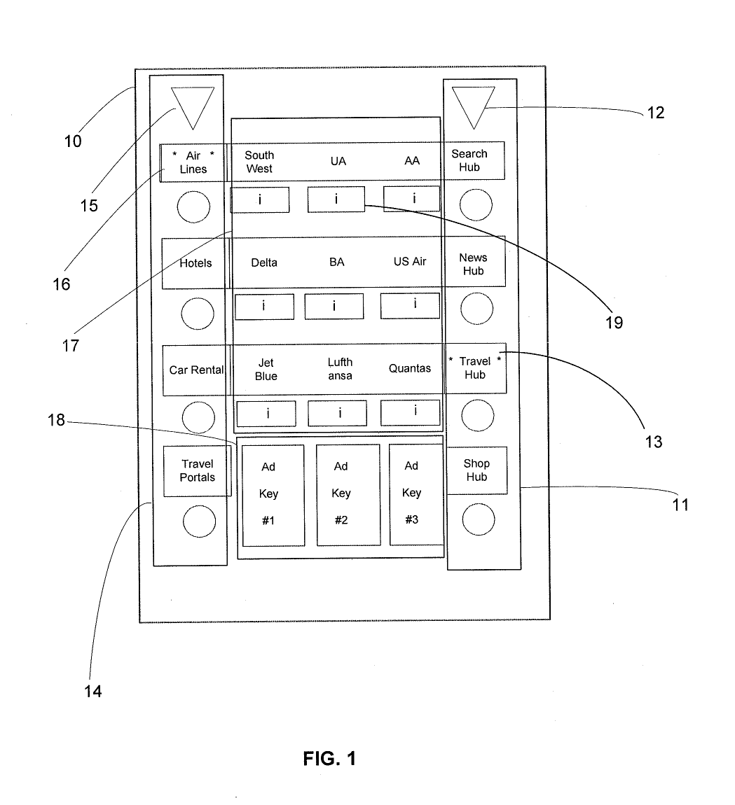

FIG. 1 illustratively depicts a user-controlled ad key keypad user interface 10 with a set of user-controlled pull advertising elements 18. The keypad user interface is implemented, for instance, either as part of a mechanical key keypad, a touchscreen display-based keypad user interface or a hybrid mechanical key/display keypad in a device. The keypad user interface comprises four sets of, hierarchically inter-related, user controlled keys with dynamic values with current states determined by the user as follows: (1) a scrollable column 11 of keys (hereinafter, “Hub Keys” and/or “a first set of keypad state determination keys”) each of which indexes into a database structure (e.g. a table) to populate the values of (2) a scrollable column 14 set of keys (hereinafter, “Category Keys” and/or “a second set of keypad state determination keys”) each of which indexes into a database structure (e.g., a table) to populate the values associated with (3) each key in a three-column by three-row array set of keys 17 (hereinafter, “Link Keys” and/or “keypad external action directive keys”) and (4) the values associated with each key in a one-row, three-key array of keys 18 (hereinafter, “Ad Keys” and/or “advertising keys”).

Each Link key has an associated information key (hereinafter, an “Information Key”), as indicated by the keys marked with an “i” in FIG. 1 that are interspersed in the three-row by three-column Link Key array. For instance, an Information Key 19 is associated with the middle Link Key in the top row of Link Keys.

The scrolling of the columns of Hub Keys and Category keys is controlled via scroll-up and scroll-down arrows, respectively located above and below each column. A scroll-down button 15 is depicted for the Category Keys, and a scroll-down button 12 is depicted for the Hub Keys.

The number of visible keys in each column and row can be changed depending on the needs of a specific implementation of this keypad system, provided, however, that the underlying indexing for determining associated values of keys remains determined according to: (1) a Hub Key selection determines a set of Category Keys and a Category Key selection from among that set of Category Keys determines a set of values of Link Keys and Information Keys, (2) the values of each of the active sets of keys are displayed, (3) the Hub and Category Keys have a scrolling control key(s) that provide the user with the means to access additional values for those key arrays, and (4) the values of the keys, and the current keypad state values as displayed, are stored in a data structure(s).

The relative locations of the sets of keys can also be changed depending on the needs of the specific implementation context for the keypad. For instance, the Hub and Category Keys could be located and arranged as horizontally scrolling rows located above and below the Link Key array. Similarly, the Ad Keys could be located at a different place with respect to the Hub, Category and Link Key arrays. Furthermore, the Ad Key array 18 could comprise more or fewer than three keys.

Additionally, the Hub and Category columns, in a touchscreen implementation, can be implemented such that the keypad implements a key (or other means, such as a finger swipe towards the nearest outside edge of the keypad in relation to the column) for each column with the functionality that a press of the key (or an activation of the gesture control) brings the applicable column of keys into the keypad user interface viewing area, and, alternatively, takes the applicable column of keys off the user interface viewing area.

In FIG. 1, the active Hub Key 13 has its display label value presented in the screen associated with that key, each key comprising a combination of a key and an associated display area. In the currently scrolled state of the Hub Key column, the display label values that are shown in FIG. 1 are: Search Hub, News Hub, Travel Hub and Shop Hub. In this instance, the Hub Key that is active (i.e., the last one selected by the user) is the Hub Key with the label “Travel Hub.” The scroll state, and the content (e.g., text, still images, video or animated images) for the displays associated with the keys, are stored in a data structure (e.g., a table) for Hub Keys. Further, the display label values for the Category Keys associated with the “Travel Hub” key are presented in the displays associated with each Category Key. In this instance, the text display labels for the current scroll state of the Category Key column are: Air Lines, Hotels, Car Rental and Travel Portals 1. In this instance, the Category Key that is active (i.e, the last one selected by the user, or the first one auto-selected by the system when the Hub Key is selected) is the Category Key with the label “Air Lines.”

The action associated with a user activation of a Hub Key is to activate the Hub Key's associated Category Keys, as stored and indexed in the applicable data structure, as well as to auto-activate the top Category Key in the Hub Key's set of Category Keys. The action associated with a user activation (or a system auto-activation) of a Category Key is to activate both (1) the active Hub/Category combination of key's associated Link Keys, and (2) to activate the Hub/Category combination of key's associated Ad Keys. In the foregoing sentences, the term “activate” means to associate a set of values and parameters index as described from the applicable data structures with the respective keys on the keypad user interface, including to display the applicable display values for the relevant keys on the displays of those keys on the keypad user interface.

In the instance depicted in FIG. 1, according to the selection of the “Travel” Hub Key and its associated “Air Lines” Category Key, and indexing in the data structure (e.g., table) for the keypad user interface, the values of a set of Link Keys are determined, and the text display labels are shown in the three-column by three-row Link Key array.

As described more fully below, the current values of the set of Ad Keys 18 are procured by indexing into a master (i.e., non-user specific) Ad Key data structure in accordance with the combination of (1) the user's settings as stored in a the user's specific profile in the user data structure (e.g., table) containing the user's profile and related information, and (2) the user's selection of (i.e., activation) of a Hub Key and a Category Key from the user's Hub Key and Category data structure (e.g., table(s)). The system indexes into the Ad Key data structure (e.g. tables) to procure and display the media (e.g., still or animated images, or video) values of the Ad Keys in the areas for each button/Ad Key display area in the Ad Key array 18. Further, the actions the system takes depending on the user interaction with an Ad Key (e.g., a key press, a fingertip swipe gesture, a multi-finger gesture, such as a pinch-to-zoom) are similarly stored in the Ad Key data structure (e.g., table), and indexed as described above, and the action is executed by the system upon the detection of a user interaction event with an Ad Key. Such an action includes, but is not limited to, the opening of a new tab in a Internet/Web browser to a link defined in the Ad Key's associated data fields, or the opening of a pop-up box on a display in which pop-up box various media is displayed according to the information in the Ad Key's data fields (such as a video, the option to purchase a product, the option of downloading or using a discount coupon, the presentation of information about a product or service, etc), or the playing of a musical tune.

If the user's profile indicates that the user has selected from among a set of master Ad Key settings that determine that the Ad Keys display content irrespective of the Hub and Link Keys selected by the user, then the Ad Key content is determined solely by the master settings which determine indexes into the master (non-user specific) data structure for the Ad Keys. These master Ad Key settings are, in one standard implementation, the default settings for the Ad Key values that govern until the user has changed them. Further, in this standard implementation, the default settings are (1) a set of values for a currently viewed set of Ad Keys are determined any time a Hub and/or Category Key is activated, and (2) the specific values for the Ad Keys are determined by a random indexing into the master Ad Key data structure (e.g., table).

The master Ad Key data structure holds no data that personally identifies a user and is not dependent in its operation in any way on personally identifiable information of a user, whether for assigning or changing current value(s) to one or more Ad Keys by indexing into the Ad Key database structure(s), or during use of the Ad Keys.

In an alternative, certain Hub and Category Keys' respective data values are assigned by indexing into a master (non-user specific) data structure depending on whether certain flags are set in the user's data structures indicating which Hub and Category Keys to index into which data structure. Further, each data structure may reside locally to the device or remotely from the device, and some or all of the active data sets associated with the then-currently displayed and active Hub, Category, Link and Ad Keys may be cached or stored locally in database structures (e.g., tables) separate from the complete database structures.

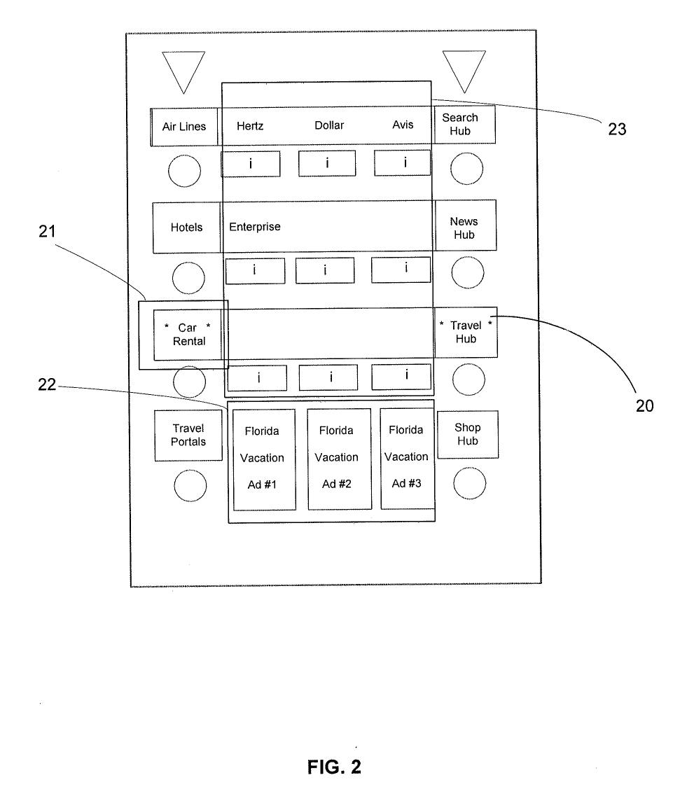

FIG. 2 illustratively depicts a user-controlled keypad user interface with pull advertising placement system wherein a Hub Key 20 with a text label “Travel Hub” has been selected by a user, and the keypad system has activated that Hub Key's Category Keys thereby associating a set of Category Keys with values indexed from a key value database structure(s) (e.g., tables) and displaying text label values for a set of top four Category Keys in a Category Key column, in accordance with a current scroll value of the Category Key column. The user has activated a third-from-top Category Key, with a text label “Car Rental” display value. A set of Link Keys 23 with values indexed from the Link Key data structure (e.g., table) according to the activated Hub Key and Category Key are displayed in the Link Key array 23. A set of Ad Key 22 with values indexed as described in the description of FIG. 1 above, are displayed in an Ad Key array 22.

In this FIG. 2, the Ad Keys 22 are displaying advertisements for Florida vacations, and there are three Ad Keys. In alternative embodiments, there can be more or fewer than three Ad Keys. For instance, there could be one large rectangular Ad Key that fills the entire area allocated to Ad Keys 22. In each Ad Key, the advertisement comprises a still image, an animated image, a video, text or other graphical or non-graphical advertisement with additional information related to the content of the Ad Key, all of which information is stored in the master Ad Key database, and indexed and presented to the user as described above in the description for FIG. 1. The additional information stored in relation to each advertisement in the master Ad Key database includes such information as advertisement category identifiers/tags and related meta-tag information, URL links and/or other actions to be taken by the system upon a user interaction event with an Ad Key (such events include, but are not limited to, opening a browser at a specific URL, sending the user a discount coupon by email, SMS or otherwise, requesting a Ad Key customer sales representative to call or otherwise contact the user (which request may include a discount identifier which is supplied to the customer sales representative for use when contacting the user), sending the user other materials (such as a free song or a movie trailer) by SMS (with embedded URL link), email, regular mail, or as otherwise indicated as the user's contact preference in the user's profile for Ad Key responses.

Note that in this instance, there is a correlation between the values of the activated Hub and Category Keys and the indexed and displayed Ad Key content. This does not need to be the case. When the user stores his/her preferences for Ad Key content as described in the description for FIG. 1 above, the user may indicate an Ad content category for all Hubs, for all Categories within a Hub and/or for each Hub/Category combination. For the most granular user Ad Key content control, the system can store user preferences for individual Ad Keys.

For example, if a user selects in his/her Ad Key preferences at any time that all Hubs Keys are to display advertisements in the category of running shoes, then all Ad Keys for any Hub/Category Key combination will display running shoe ads (to the extent ads tagged as running shoe ads are present in the master Ad Key database, and, if none are present, the system displays random ads pulled from the Ad Key database).

Whenever the user changes his/her ad category preference (whether for all Ad Keys, or for Ad Keys associated with specific Hubs Keys or specific Hub/Category key combinations), the ads relevant to that change are indexed to the new ad category preference of the user. In the running shoe ad preference example, the user can change that preference globally across the entire keypad user interface for all Ad Keys by selecting a new ad category for all Hub Keys, or the user can change that preference or any specific Hub and/or Category Keys. In this running shoe example, if the user were to activate a Hub that is assigned to Entertainment, and the user were to change his/her ad category preference just for that Hub to “movie tickets,” then the system will deliver “movie ticket”-tagged ads (from the master Ad Key database) to the Entertainment Hub when the user is in that Hub, and the system will deliver “running shoe”-tagged ads to all the Ad Keys in all the other Hubs whenever any of those other Hubs are activated (in use, i.e. the values relevant to the current state of the keypad user interface as indexed as described above are presently displayed on and associated with the Hub/Category/Link keys on the keypad) by the user.

In this way, the user controls and selects the advertisements on the Ad Keys that the system displays as the user uses the keypad system, and the user has both macro and micro control over the advertisements that are displayed anywhere in the system, and the user can make changes any time during use of the system, and the changes take immediate effect.

For instance, if a user is walking down a street, and had been shopping for shoes (and, hence, had set the entire system for “shoe ads” across all Hub Keys) and had bought the shoes, and the user is now looking for lunch and then a movie, the user can set any or all Hubs to lunch discounts (including, for instance, geographic location as an Ad Key master or sub-category preference), and one or more Hubs or Categories to a movie ticket advertisement category. The advertisement content geographic location parameter/filter preference of the user is stored by the keypad user interface system by giving the user the option of setting (and changing on-the-go) his/her geographic preference for ads at a master level (that controls all advertisement categories that will be indexed for the user from the Ad Key master database), and by giving the user the option of setting (and changing on-the-go) his/her geographic preference for ads by category. For instance, the user may set no master geographic ad filter, or may set the master geographic ad filter locally to the city (or places) where the user frequents, and, for any specific Ad Category selection, the user is given the choice of indicating a specific geographic (or other relevant filter/preference) to that category. For instance, if a user lives in New York, but takes vacations to Florida, the user could set the ad category preferences for the Travel Hub Key to filter for (1) all travel ads (or, specifically, for instance, air line, hotel or car or resort ads), and (2) a geographic preference for Florida, while at the same time the user sets the ad category preferences for the Shop Hub Key's Shoe Category Key to (1) women's dress shoes, and (2) a geographic preference for New York City.

The granularity of the user's ad category preference selections is variable, and relates to the scope and detail within the master Ad Key category database.

When the user has not established specific preferences for any or all of the Hub Keys or Category Keys, or has intentionally set some of them at the system ad category random setting, then the system will deliver random ads pulled from the master Ad Key data structure (e.g, table) for those contexts where the setting is at random, and this will include delivering any number of Ad Keys in any specific Ad Key area from one to the maximum allowed by the system, and in whatever sizes up to the maximum allowed by any specific Ad key area.

The system can enable the option for each user, in his/her master ad delivery preference settings, to indicate a preferred number of Ad Keys per Category Key, from one to the maximum number allowed by the system. The system will attempt to deliver ads sized according to the foregoing constraints from the master Ad Key data structure, but will delivery ads regardless if no ads meet the key number/size constraints indicated by the user.

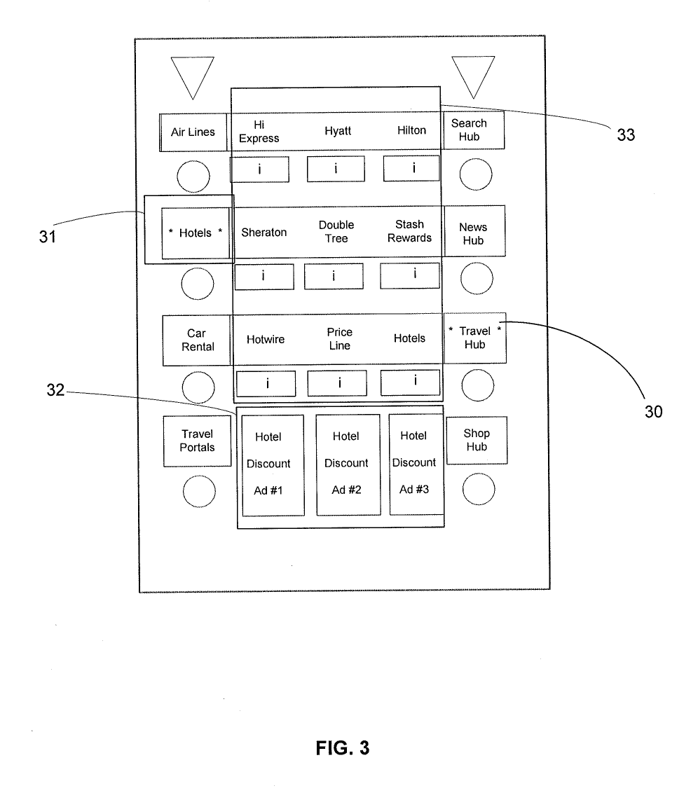

FIG. 3 illustratively depicts a user-controlled pull advertising placement keypad user interface system wherein a Hub Key 30 with a text label “Travel Hub” has been selected by the user, and the system has activated that Hub Key's Category Keys thereby associating a set of Category Keys with values indexed from a key value database structure(s) (e.g., tables) and has displayed text label values for the top four Category Keys in a Category Key column, in accordance with a current scroll value of the Category Key column. The user has activated the second-from-top Category Key 31, with the text label “Hotels” display value. A set of Link Key values indexed from the Link Key data structure (e.g., table) according to the activated Hub Key and Category Key are displayed in a Link Key array 33. A set of Ad Key values indexed as described in the descriptions above, are displayed in an Ad Key array 32.

In this FIG. 3, the Ad Keys 32 are displaying advertisements for hotel discounts, and there are three Ad Keys. The discussion for the Figs above describe how this system works to provide these or other Ad Key content in this or other contexts, according to the user's stored preference selections and the user's currently activated state of the keypad's Hub and Category Keys.

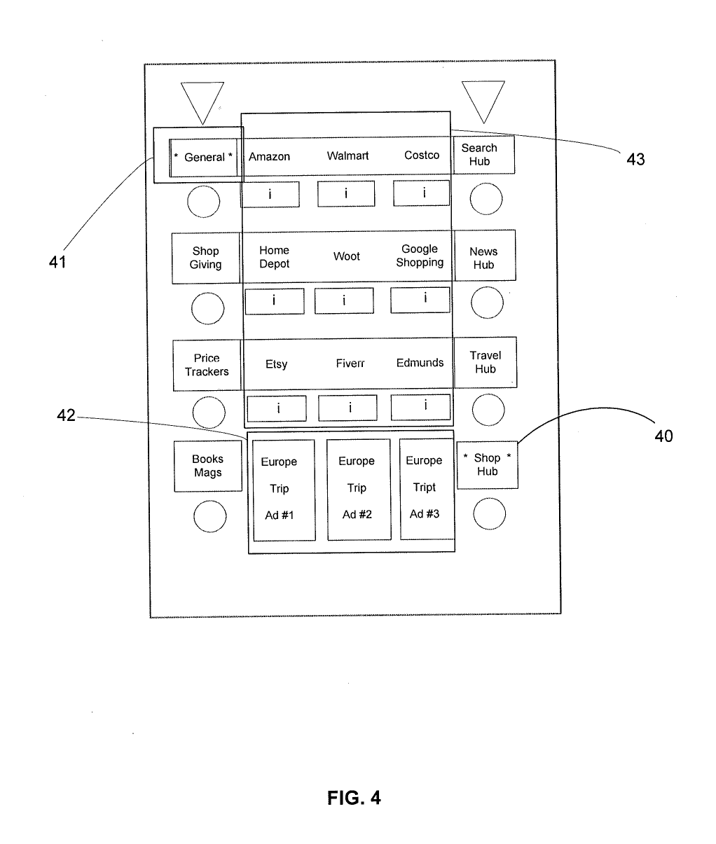

FIG. 4 illustratively depicts a user-controlled pull advertising placement keypad user interface system wherein a Hub Key 40 with a text label “Shop Hub” has been selected by the user from among a currently displayed set of active values of a Hub Key column's current scroll state, and the system has activated that Hub Key's Category Keys thereby associating a set of Category Keys with values indexed from the key value database structure(s) (e.g., tables) and displaying text label values for the top four Category Keys in the Category Key column, in accordance with a current scroll value of the Category Key column. The user has activated a second-from-top Category Key 41, with a text label “Hotels” display value. A set of Link Key values indexed from the Link Key data structure (e.g., table) according to the activated Hub Key and Category Key are displayed in a Link Key array 43. A set of Ad Key values indexed as described in the descriptions above, are displayed in an Ad Key array 42.

In this FIG. 4, the Ad Keys 42 are displaying advertisements for “Europe Trip” ad category, and there are three Ad Keys. The discussion for the Figs above describe how this system works to provide these or other Ad Key content in this or other contexts, according to the user's preference selections and controls.

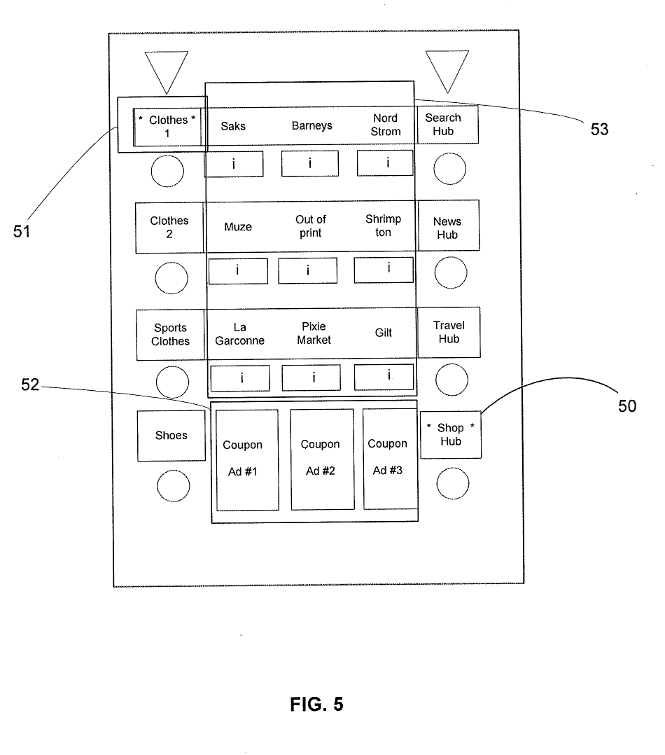

FIG. 5 illustratively depicts a user-controlled pull advertising placement keypad user interface system wherein a Hub Key 50 with a text label “Shop Hub” has been selected by the user, and the system has activated that Hub Key's Category Keys thereby associating the Category Keys with values indexed from the key value database structure(s) (e.g., tables) and displaying text label values for the top four Category Keys in a Category Key column, in accordance with a current scroll value of the Category Key column. The user has activated a second-from-top Category Key 51, with a text label “Clothes 1” display value. A set of Link Key values indexed from the Link Key data structure (e.g., table) according to the activated Hub Key and Category Key are displayed in a Link Key array 53. A set of Ad Key values indexed as described in the descriptions above, are displayed in an Ad Key array 52.

In this FIG. 5, the Ad Keys 52 are displaying advertisements for “Coupon Ad” ad category, and there are three Ad Keys. The discussion for the Figs above describe how this system works to provide these or other Ad Key content in this or other contexts, according to the user's preference selections and controls.

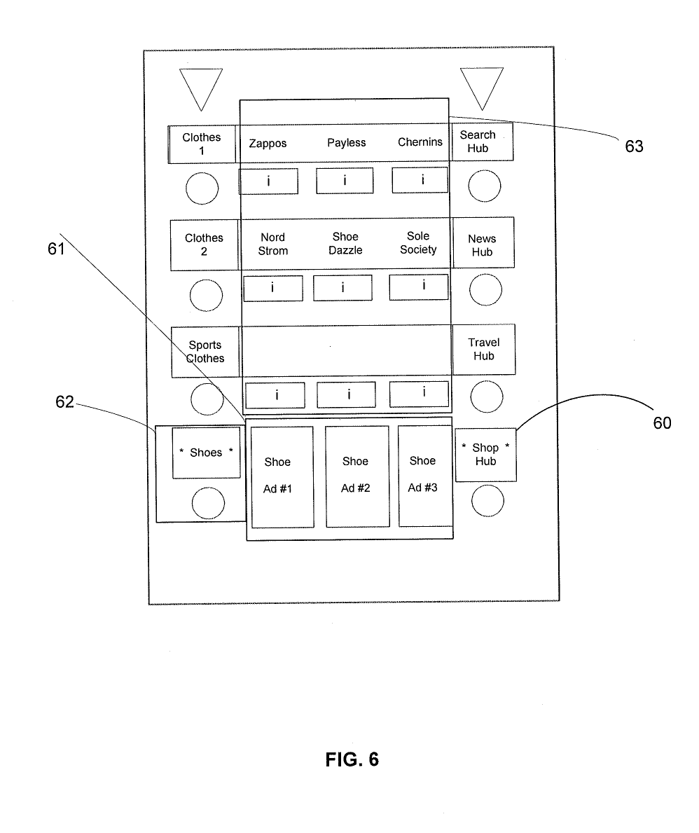

FIG. 6 illustratively depicts a user-controlled pull advertising placement keypad user interface system wherein a Hub Key 60 with a text label “Shop Hub” has been selected by the user, and the system has activated that Hub Key's Category Keys thereby associating a set of Category Keys with values indexed from a key value database structure(s) (e.g., tables) and displaying text label values for a set of top four Category Keys in the Category Key column, in accordance with a current scroll state value of the Category Key column. The user has activated a second-from-top Category Key 61, with a text label “Shoes” display value. A set of Link Key values indexed from the Link Key data structure (e.g., table) according to the activated Hub Key and Category Key are displayed in a Link Key array 63. A set of Ad Key values indexed as described in the descriptions above, are displayed in an Ad Key array 62.

In this FIG. 6, the Ad Keys 62 are displaying advertisements for “Coupon Ad” ad category, and there are three Ad Keys. The discussion for the Figs above describe how this system works to provide these or other Ad Key content in this or other contexts, according to the user's preference selections and controls.

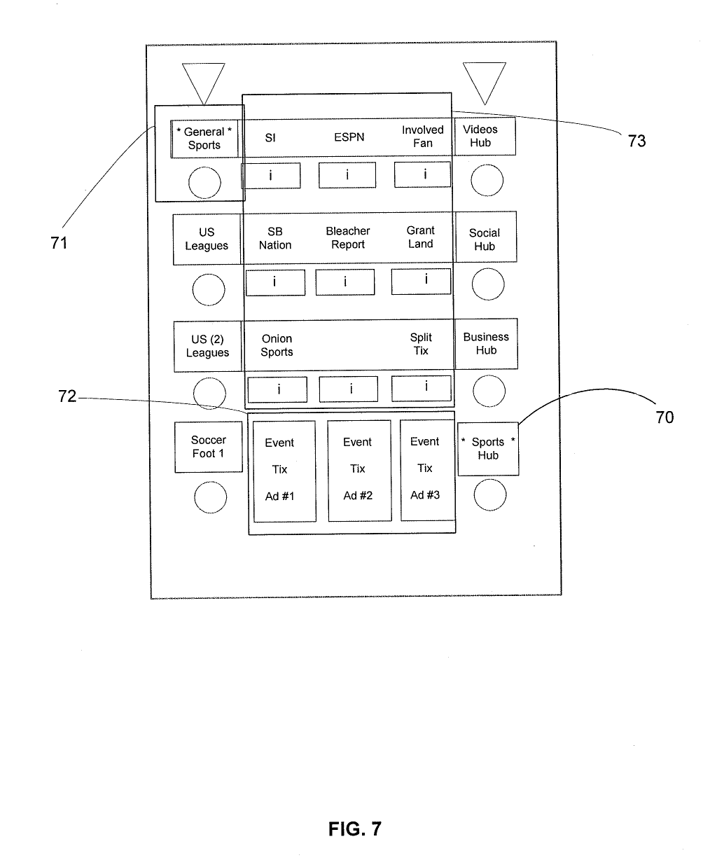

FIG. 7 illustratively depicts a user-controlled keypad pull advertising placement system wherein a Hub Key 70 with a text label “Sports Hub” has been selected by a user, and the system has activated that Hub Key's Category Keys thereby associating a set of Category Keys with values indexed from a key value database structure(s) (e.g., tables) and displaying text label values for a top four set of Category Keys in a Category Key column, in accordance with a current scroll value of the Category Key column. The user has activated a second-from-top Category Key 71, with a text label “General Sports” display value. A set of Link Key values indexed from the Link Key data structure (e.g., table) according to the activated Hub Key and Category Key are displayed in a Link Key array 73. A set of Ad Key values indexed as described in the descriptions above, are displayed in an Ad Key array 52.

In this FIG. 2, the Ad Keys 72 are displaying advertisements for “Event Tix Ad” ad category, and there are three Ad Keys. The discussion for the Figs above describe how this system works to provide these or other Ad Key content in this or other contexts, according to the user's preference selections and controls.

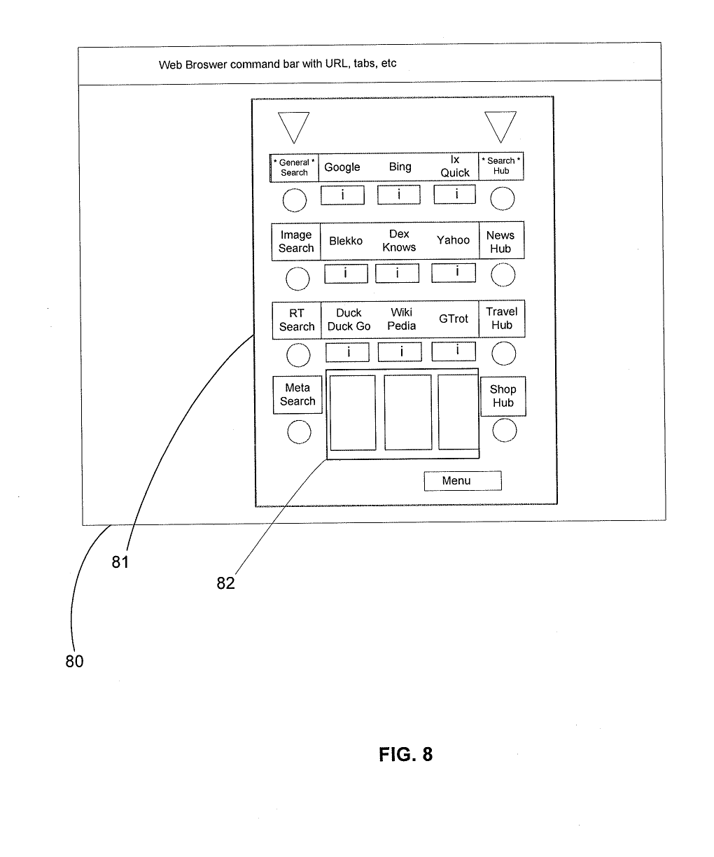

FIG. 8 illustratively depicts an exemplary environment wherein a keypad user interface 81 described above, with a set of user-controlled pull advertising elements 82, is implemented as a software application delivered via a web browser application 80, and wherein the keypad user interface 81 is implemented as a combination of keypad graphical user interface that also acts as the front end access management system for a series of relational database structures stored in servers remote from the device with the monitor on which the keypad user interface is displayed for use, in which database structures, a master Ad key database structure, a user profile database structures (including Ad Key preferences) and user Hub, Category and Link Key database structures reside.

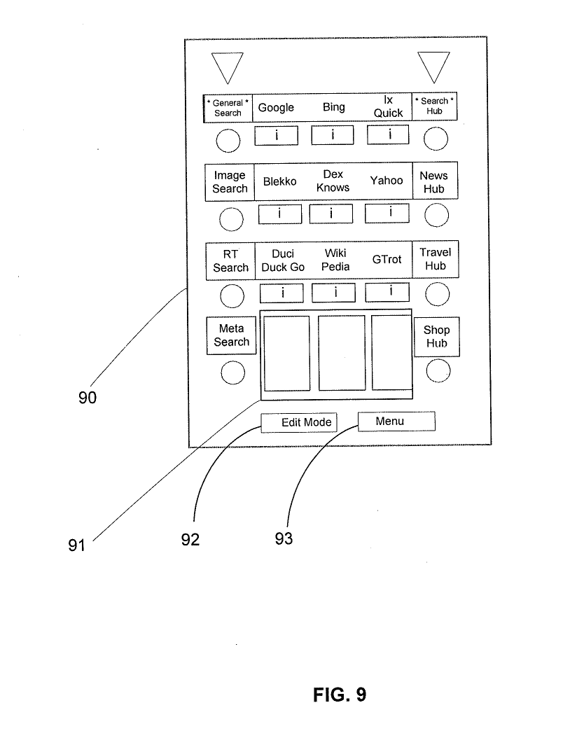

FIG. 9 illustratively depicts a view of an exemplary environment wherein a keypad user interface 90 described above, with a set of user-controlled pull advertising elements 91, is implemented wherein an “edit mode” key 92 operates as a toggle for the user to change the state of the keypad user interface from standard operating mode to an edit mode wherein a user interaction event with a Hub, Category, Link or Ad Keys triggers a series of menus that prompt and enable the user to edit parameters related to that Key, including, the ad category and filter/parameter preferences of the user applicable to that Key (and its related set of other keys, as related per the operation of the keypad user interface as described above).

This FIG. 9 further depicts a key 93 labeled “menu” which, upon a user interaction event with this key, opens a menu of user profile options, which options include ones for controlling the Ad Key filters/parameters as described in relation to FIG. 1 above.

The “menu” and “edit” keys, and the mode of operation of these keys are, alternatively, implemented by other means and in other locations. For instance, the “edit mode” can be implemented as part of the items that are presented to the user when the “menu” key is selected, or, alternatively, a long press (defined, for instance, as a finger press or mouse click or horizontal (or other finger swipe) or a double finger tap) on a Hub, Category, Link or Ad key could trigger the edit menu for that key. Alternatively, one or both of these keys can be implemented as hot keys and/or keys with dual functions wherein the “menu” or “edit mode” function is activated by simultaneously pressing (or pressing and holding) another key, such as a shift, control, alt or other key.

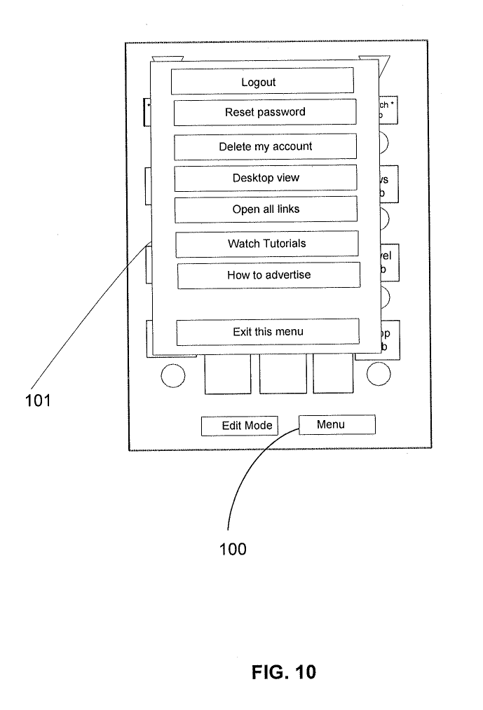

FIG. 10 illustratively depicts a user profile menu 101 that opens when the user selects a “menu” key 100 (which menu key is also described in relation to FIG. 9 above) on a user-controlled keypad interface system. Items within the menu include a “manage ads” option (not shown here), that, when selected by the user, trigger a series of nested (or other) menus based on choices made by the user from among previous (other) menu items which let the user control/manage his/her Ad Key filters/parameters as described in relation to FIG. 1 above.

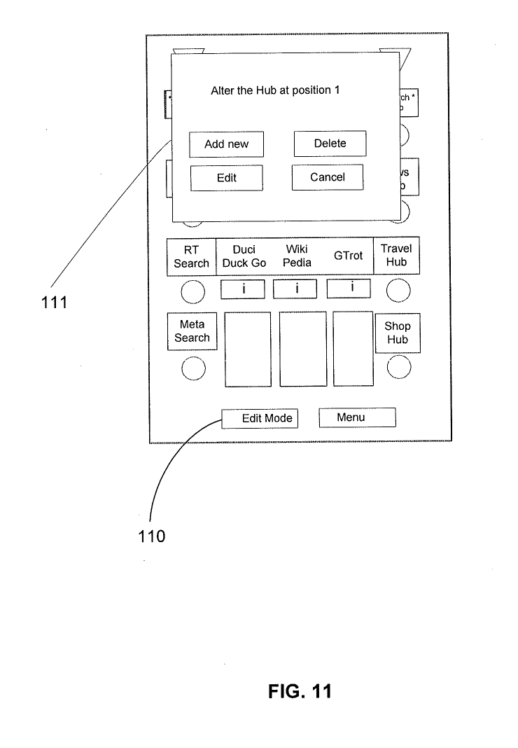

FIG. 11 illustratively depicts an edit mode key 110 (which edit mode key is also described in relation to the Figs. above) that toggles the state of the user-controlled keypad user interface system between its standard operating mode and its edit mode. When the keypad user interface is in “edit mode” and a user thereafter selects a Hub, Category, Link or Ad Key, an edit menu 111 opens to enable the user to edit the fields related to that key in the user's data structures (e.g., tables) related to that key. The items within the menu include an “edit” option, that, when selected by the user, trigger a series of nested (or other) menus based on choices made by the user from among previous (or other) menu items which let the user control/manage his/her Ad Key filters/parameters for the specific key as described in relation to FIG. 1 above.

In the Figs herein, menus appear directly over the keypad user interface, which is an optimal implementation used, for instance, in the context of devices with small, touchscreen where the entire keypad user interface and its management tools appear entirely within the parameters of the touchscreen dimensions. In other device contexts, these menus can appear on displays separate from the keypad user interface, on areas of a display separate from the keypad user interface, and/or on some or all of the keypad user interface's displays elements.

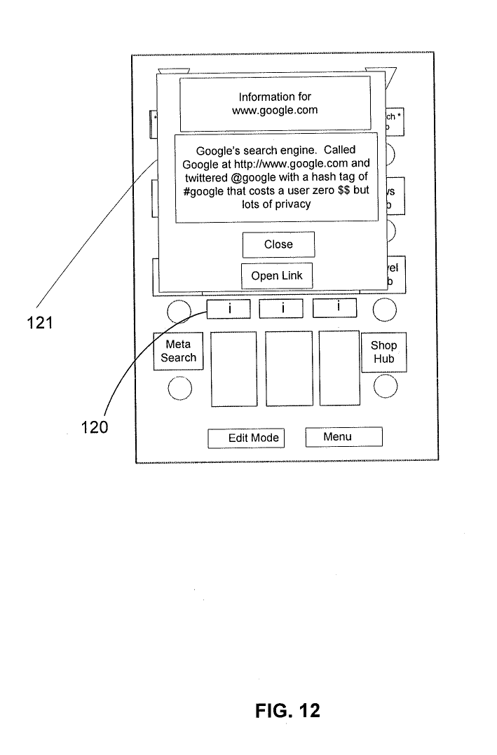

FIG. 12 illustratively depicts an information key 120 (as more fully described in relation to FIG. 1 above) for which a user, through selection of the Information Key, has triggered an activation event that has resulted in an “Information” box appearing that provides certain information about the current state of the combined display/key unit of which the Information Key is a part, which information is indexed by the keypad user interface system from the fields related to that key in the user's data structures for his/her Hub, Category and Link Keys. The information in the Information Key's box 121 can be text (as shown here), images (still, animated or video), ads (or a combination thereof) or other media or information, as stored in the relevant data structure for that Information Key. The information stored and displayed for that Information Key's box 11 can be directly edited and changed or replaced by the user, provided that any advertising content associated or displayed in the Information Key box 121 is determined by the user's Ad Key and other settings as editable as described in the descriptions preceding the description of this FIG. 12. In other words, ad preferences/settings governing ads displayed in Information Keys is controlled by essentially the same two components as described above for Ad Keys: a individual ad key edit mode and the user's master ad preference settings.

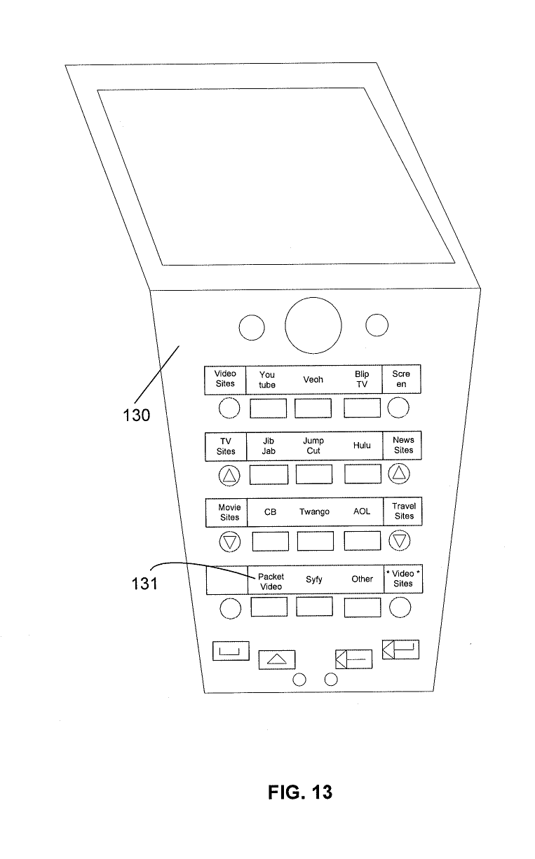

FIG. 13 illustratively depicts a handheld computing and communications device (130) with a keypad user interface system comprising a hybrid mechanical key with integrated display component construction with Ad Keys 131. Alternatively, this keypad implementation is solely a touchscreen on the keypad portion of the device, and the bifurcated, dual display/key single unit keys are depicted via a graphical user interface on the touchscreen.

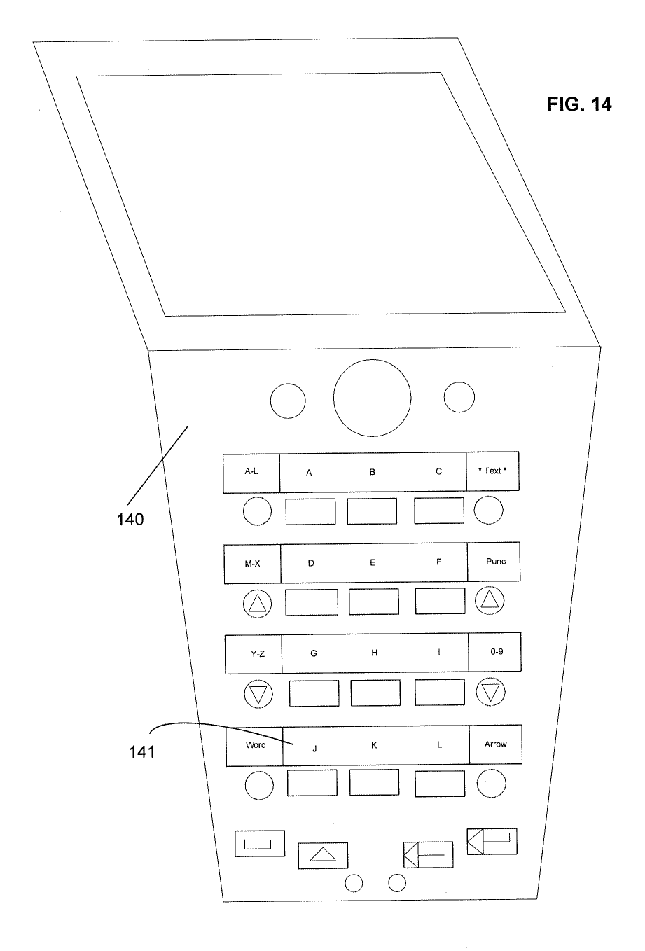

FIG. 14 illustratively depicts an implementation of a computing and communications device (140) with a user-controlled keypad user interface system comprising a hybrid mechanical key with integrated display component construction with Ad Keys 141 wherein the Ad Keys are bifurcated in the same manner as the Link Keys with a mechanical key component and a display component. Alternatively, this keypad implementation is a touchscreen component for the keypad portion of the device.

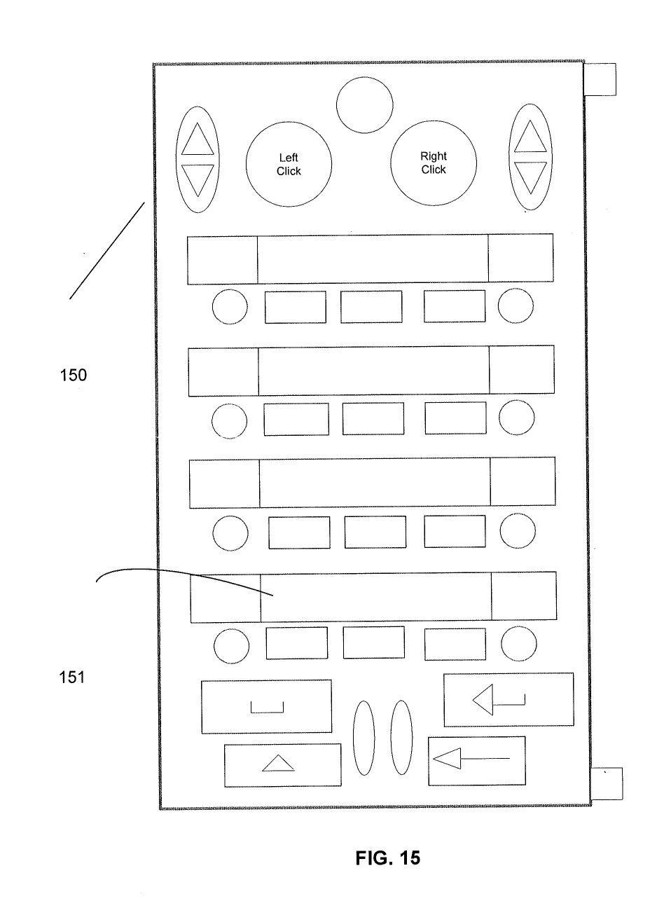

FIG. 15 illustratively depicts an implementation of a stand-alone keypad device (150) with a user-controlled keypad user interface system comprising a hybrid mechanical key with integrated display component construction with Ad Keys 151 wherein the Ad Keys are bifurcated in the same manner as the Link Keys with a mechanical key component and a display component. Alternatively, this keypad implementation incorporates a single touchscreen component on the surface of the device (with or without mechanical keys above and below the Hub, Category, Link and Ad Key arrays, and with or without a physical membrane overlay for providing tactile feedback to the fingertips for locations and activations of the keys (combined, or not, with haptic feedback).

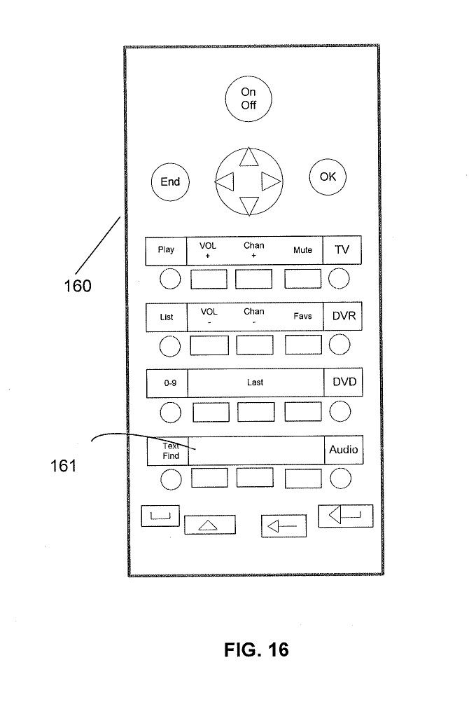

FIG. 16 illustratively depicts an implementation of a remote control device (160) for wirelessly controlling directly or through intermediary devices (such as a router, server, tablet, DVR, cable TV box or other device) a TV or a computing device or monitor, with a user-controlled keypad user interface system comprising a hybrid mechanical key with integrated display component construction with Ad Keys 161 wherein the Ad Keys are bifurcated in the same manner as the Link Keys with a mechanical key component and a display component. Alternatively, this keypad implementation incorporates a single touchscreen component on the surface of the device (with or without mechanical keys above and below the Hub, Category, Link and Ad Key arrays, and with or without a physical membrane overlay for providing tactile feedback to the fingertips for locations and activations of the keys (combined, or not, with haptic feedback).

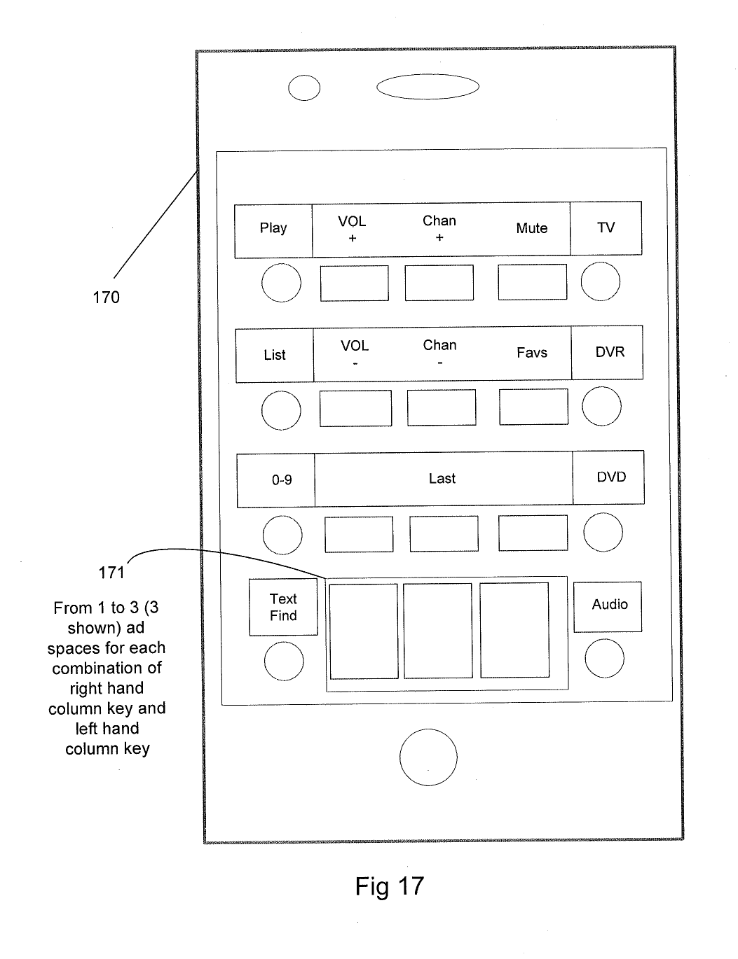

FIG. 17 illustratively depicts an implementation of a touchscreen smartphone device (170) with a user-controlled keypad user interface system with Ad Keys 161.

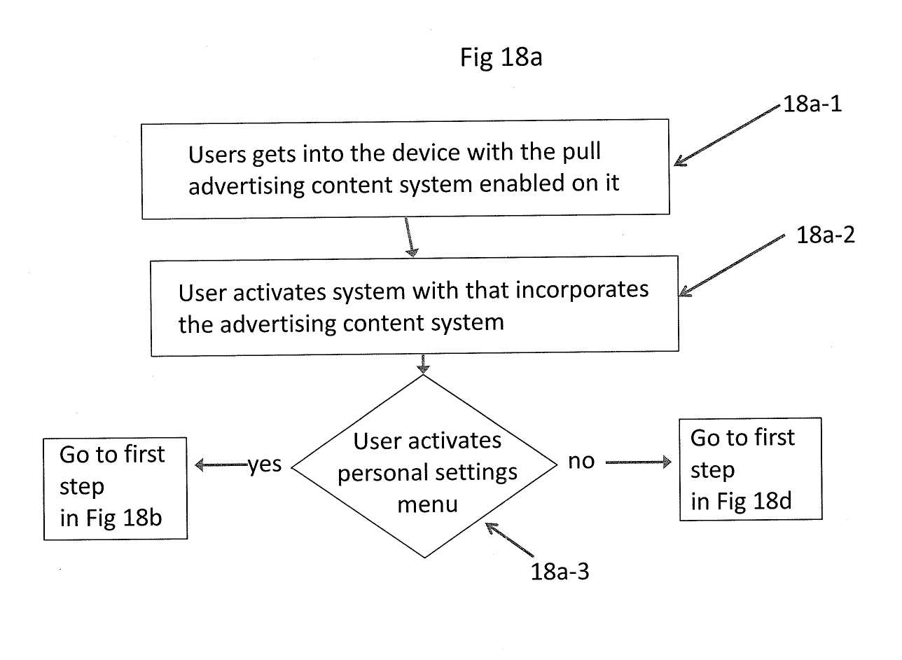

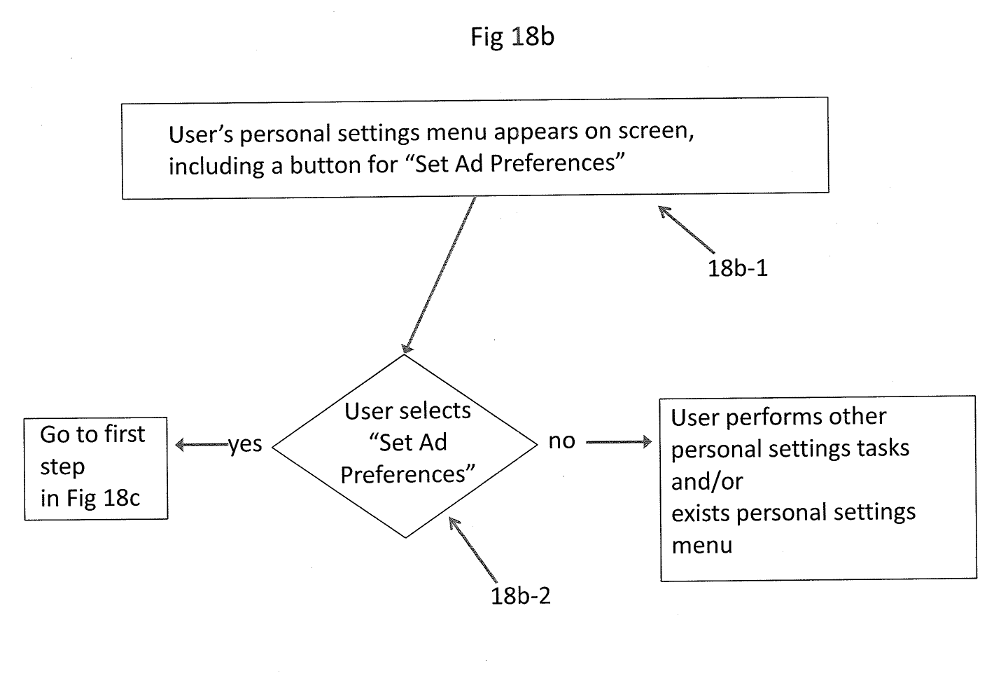

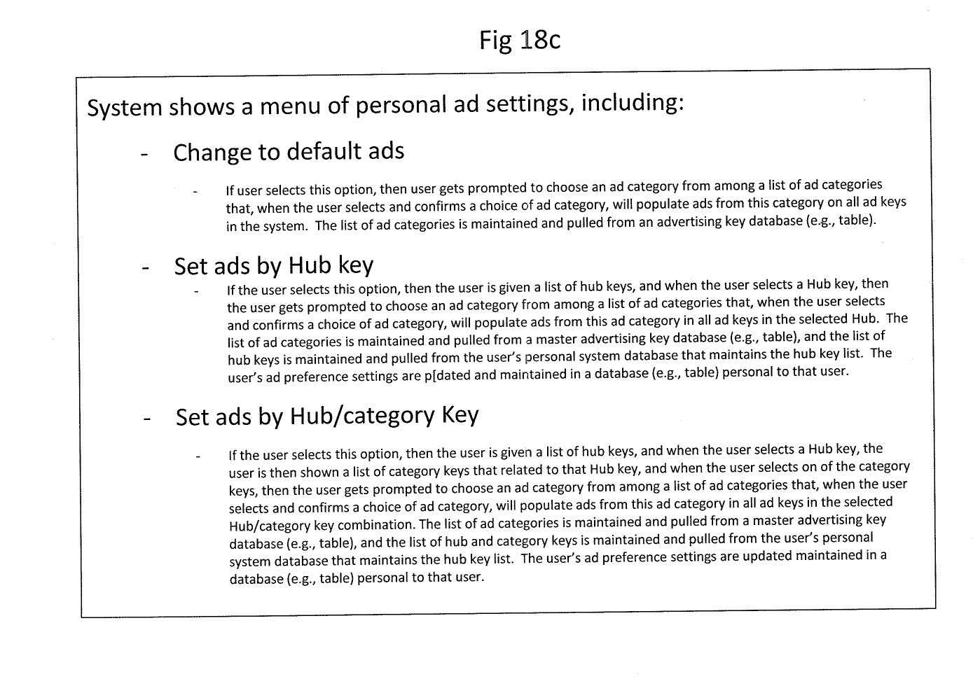

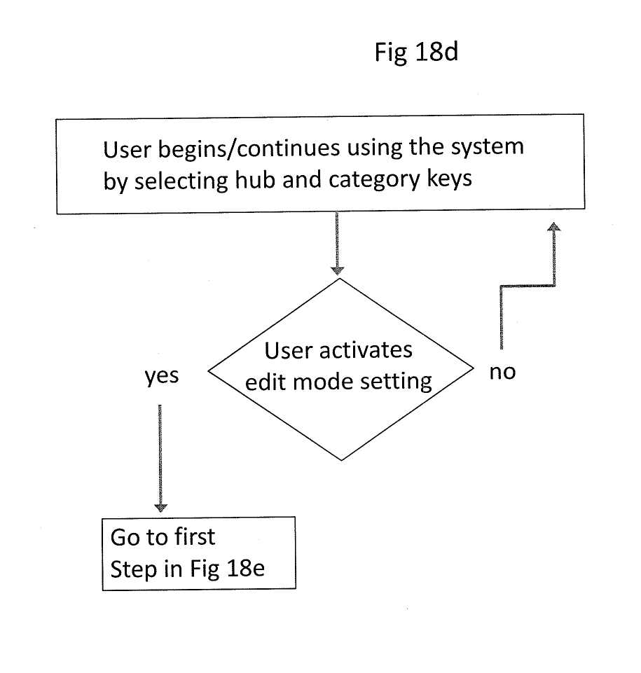

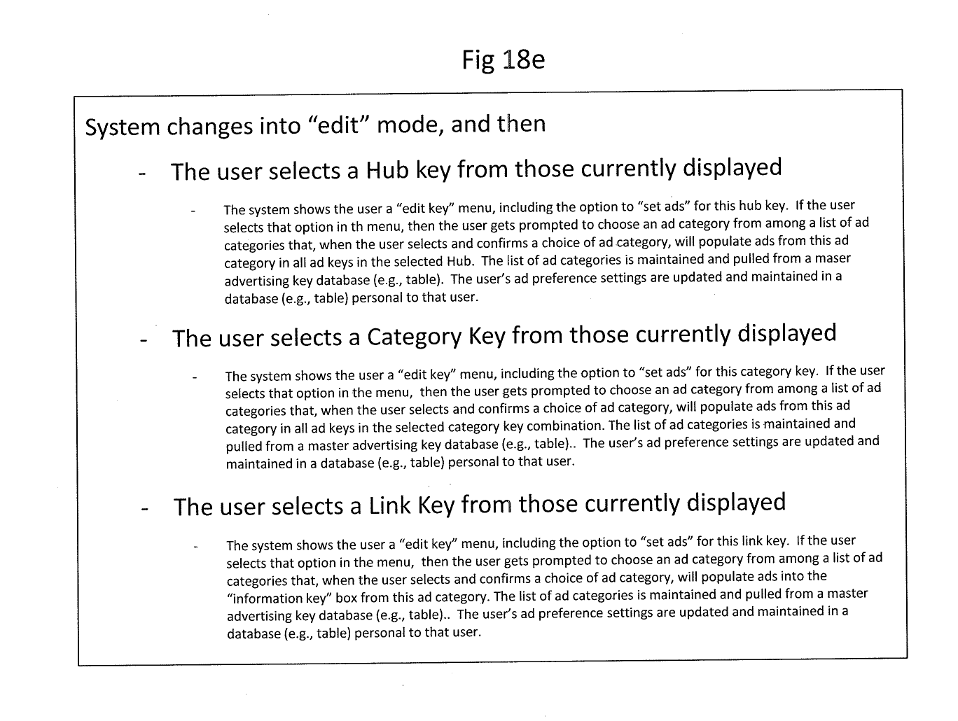

FIG. 18a illustratively depicts an exemplary flow chart summarizing a first set of steps by which a user activates a user-controlled keypad user interface system as described above, and activates (or not) a “menu” key depicted and described in certain of the Figs. above. In Step 18a-1, the user turns on the device in which the keypad user interface system is implemented. In step 18a-2, the user activates that keypad user interface system. At this time, the keypad user interface system indexes into its related data structures (e.g., tables), as described above, to establish its initial mode, including the initial values for the Hub, Category, Link and Ad Keys, and displays the associated labels in association with the respective keys. If, at any time during operation of the keypad user interface, the user activates the “menu” key (step 18a-3), the next steps in the flowchart are depicted in FIG. 18 below.

FIG. 18b is an exemplary flowchart summarizing a set of steps for the context when a user has activated a “menu” key as described in FIG. 18a above. Pursuant to the activation of the “menu” key, a menu of options for accessing/changing/setting/viewing the user's personal, master settings for a user-controlled keypad user interface system appear (step 18b-1) including a menu item for accessing/changing/setting/viewing the user's master Ad Key preferences. These preferences include, for instance, the various settings controlling the Ad Keys in the user controlled keypad user interface that are described in relation to the Figs described above. At such time as a user selects this menu item (step 18b-2), the next flow chart steps are depicted in FIG. 18 below.

FIG. 18c describes the menu options and associated actions when a user opens the menu of personal ad settings as described in the description for FIG. 18b.

FIG. 18d is an exemplary flow chart summarizing a set of steps for the context when a user elects to access/change/set/view the user's settings, including ad parameters/filters, for individual Hub and/or Category Keys.

FIG. 18e describes the menu options and associated actions when a user opens the menu of personal ad settings for individual Hub and/or Category Keys as described in the description for FIG. 18d.

The data structures referenced in this application comprise a set of relational database structures (e.g. interlinked tables) with a set of fields associated with each data structure, which include a user-specific profile data structure, a user-specific series of data structures for holding the values associated with the operation of each of the user's Hub, Category, Link and Ad Keys, a master system user data structure and a master system advertisement inventory data structure.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computing device incorporating a user-controlled keypad user interface facilitating user-controlled advertising on the keypad, the device comprising:
a keypad user interface comprising multiple sets of keys, each of these four sets of keys is separate and distinct from the each of the other sets of keys:
a first set of keypad-state determination keys,
a second set of keypad-state determination keys,
a set of keypad external action directive keys, and
a set of advertising keys,
and, wherein
data structures store values and data for the keypad,
and, wherein
a combined selection from among the first set of keypad-state determination keys and among the second set of keypad-state determination keys determines the values of both the set of keypad action keys and the set of advertising keys by setting a set of index values for retrieving the values and data for the sets of keys from the keypad data structures.

2. The device of claim 1 further comprising an accounting function that associates selection of one of the set of advertising keys with a compensation parameter for the advertising content associated with the advertising key.

3. The device of claim 1 further comprising a separate control feature that selects among sets of values of the first set of keypad-state determination keys.

4. The device of claim 1 further comprising a separate control feature that selects among sets of values of the second set of keypad-state determination keys.

5. The device of claim 2 wherein the compensation parameter defines a charge to a content sponsor associated with a particular one of the dedicated launch keys.

6. The device of claim 1 wherein some or all of the keys comprise keys constructed of mechanical components.

7. The device of claim 1 wherein some or all of the keys comprise keys displayed on a touchscreen component.

8. The device of claim 1 wherein some or all of the keys comprise a hybrid construction of mechanical components and displays.

9. The device of claim 1 wherein some or all of the keys comprise a hybrid construction of mechanical components and touchscreen displays.
